(19) United States
(12) Patent Application Publication
(10) Pub. No.: US 2009/0272707 A1
(43) Pub. Date: Nov. 5, 2009

(54) POCKET DOOR SYSTEM

(76) Inventor: Jeff H. Layton, Toronto (CA)

Correspondence Address: Fay Sharpe LLP, 1228 Euclid Avenue, 5th Floor, The Halle Building, Cleveland, OH, 44115, US

(21) Appl. No.: 12/499,890

(22) Filed: Jul. 9, 2009

Related U.S. Application Data
(62) Division of application No. 11/482,361, filed on Jul. 7, 2006.

(51) Int. Cl. A47F 5/08; E06B 1/52; A47F 5/00

(52) U.S. Cl. 211/153; 49/372; 211/162

(57) ABSTRACT

There is disclosed a pocket door system. The pocket door system comprises a pocket door sized and shaped to fit into a pocket opening in a wall. Associated with the pocket door is a storage means which is sized and shaped to fit into the pocket opening in the pocket door. The pocket door system also comprises a means for sliding the pocket door and the associated storage means into and out of the pocket opening. A kit for installing a pocket door system is also disclosed.

### FIELD OF THE INVENTION

This invention relates generally to an improved pocket door system.

### BACKGROUND OF THE INVENTION

Pocket door systems have become an increasingly preferred door system in the construction of residential and commercial building structures in which room space is limited.

Typically, the pocket door system is mounted within a rough opening provided in a non-bearing partition wall, adjacent to a doorway. In such a system, it is common to suspend the door on a pair of trolley assemblies which ride in a track fixed above the top of the pocket door. For ease of installation, the pocket door system is commonly mounted prior to the installation of plasterboard or another similar wall surface covering. Once the pocket door system installation is complete, the doorway is opened by rolling the pocket door into a pocket formed by the door assembly and wall surface covering. Similarly, the doorway may be closed by rolling the pocket door from the pocket into the doorway.

The ability of storing the pocket door in the pocket systems when the doorway is open has advantages for smaller rooms, since, for example, the dedication of room space to accommodate a standard hinged door is not necessary.

Although the known pocket door assemblies are useful in the construction of residential and commercial building structures in which room space is limited, there is a continuing need to find ways to make the most of the limited space in buildings.

### SUMMARY OF THE INVENTION

The present invention is directed to a simple, cost efficient way in which to improve the space saving advantages of conventional pocket door systems by associating with the pocket door with a means for storing various articles.

Accordingly, one aspect of the present invention is to provide a pocket door system comprising:
a pocket door sized and shaped to fit into a pocket opening in a wall;
a storage means associated with said pocket door, said storage system being sized and shaped to fit into said pocket opening with said pocket door; and
a means for sliding said pocket door and said associated storage means into and out of said pocket opening.

In another aspect of the present invention, there is provided a kit for installing a pocket door comprising:
a pocket door sized and shaped to fit into a pocket opening in a wall;
a storage means associated with said pocket door, said storage means being sized and shaped to fit into said pocket opening with said pocket door; and
a means for sliding said pocket door and said associated storage means into and out of said pocket opening.

### BRIEF DESCRIPTION OF THE DRAWINGS

Reference will now be made to the preferred embodiments of the present invention with reference, by way of example only, to the following drawings in which:

FIG. 1 is a perspective view of a partition wall having a pocket door system constructed in accordance with the principles of the invention and installed therein with some of the component parts omitted;

FIG. 2 is a front view of the partition wall having the pocket door system shown in FIG. 1 showing a sliding means and rough frame opening in phantom outline;

FIG. 3 is a side view of the partition wall having the pocket door system shown in FIG. 2;

FIG. 4 is a perspective view of FIG. 3 showing the upper hanger assembly secured to the header and the pocket door and associated storage means being suspended therefrom;

FIG. 5 is a cross-sectional view of the track of the upper hanger assembly of FIG. 4;

FIG. 6a is a side view of a trolley assembly of FIG. 4;

FIG. 6b is a front view of the trolley assembly of FIG. 6a;

FIG. 7a is a perspective view of the lower sliding track;

FIG. 7b is a side view of the lower sliding track of FIG. 7a;

FIG. 8a is a perspective view of the partition wall having the pocket door system of FIG. 2 with the wall surface structure removed to illustrate the use of composite stud assemblies;

FIG. 8b is an enlarged perspective view of region 8b of FIG. 8a showing the connection of the composite stud assembly to the track of the upper hanger assembly;

FIG. 8c is an enlarged exploded view of region 8c of FIG. 8a showing the connection of the composite stud assembly to a floor plate;

FIG. 9 is a perspective view of an adjustable shelf according to an embodiment of the invention;

FIG. 10 is a side view of an alternative embodiment of the invention in which the pocket door and associated storage means are mounted for independent sliding movement into and out of the pocket opening.

### DETAILED DESCRIPTION OF THE PREFERRED EMBODIMENTS

The present invention is described in more detail with reference to exemplary embodiments thereof as shown in the appended drawings. While the present invention is described below including preferred embodiments, it should be understood that the present invention is not limited thereto. Those of ordinary skill in the art having access to the teachings herein will recognize additional implementations, modifications, and embodiments which are within the scope of the present invention as disclosed and claimed herein. In the figures, like elements are given like reference numbers. For the purposes of clarity, not every component is labelled in every figure, nor is every component of each embodiment of the invention shown where illustration is not necessary to allow those of ordinary skill in the art to understand the invention.

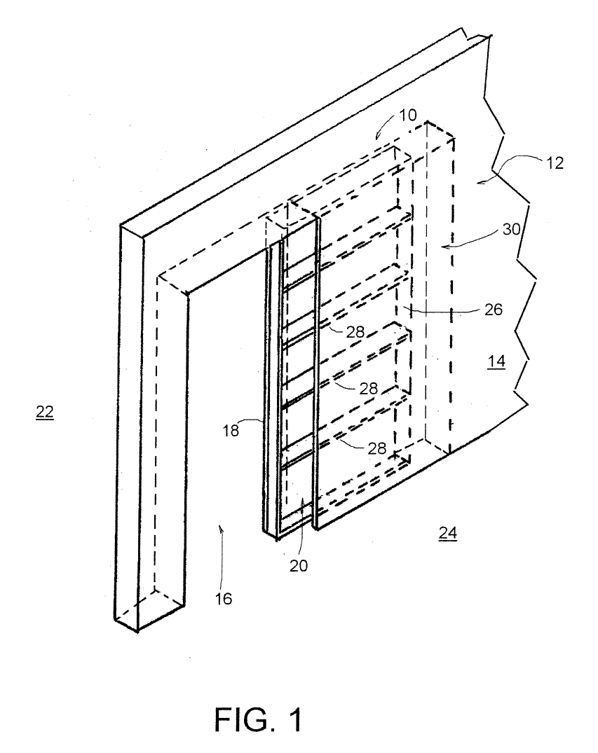

Referring now to the drawings, and initially to FIG. 1, a pocket door system, designated generally by the reference numeral 10 is shown installed within a finished wall assembly, designated generally by the reference numeral 12. Some of the component parts of the pocket door system 10, which are discussed in detail below, are omitted from FIG. 1 for clarity of the principles of the present invention. The finished wall assembly 12 comprises a wall surface structure 14 of plasterboard, or the like, and includes a finished doorway opening 16 which may be trimmed with a typical casing (not shown). The pocket door system 10 includes a pocket door 18 and a storage means 20 associated with the pocket door 18, both of which may be constructed from a variety of materials, including, for example, glass, wood, and composites. As shown in FIG. 1, the pocket door system 10 separates two rooms, with the pocket door 18 facing one room 22, and the associated storage means 20, facing the second room 24. The storage means 20, depicted in FIG. 1 is in the form of a storage cabinet 26 secured to one side of the pocket door 18. Although the storage cabinet 26 is shown to contain a plurality of open shelves 28, it will be appreciated by those skilled in the art that the storage cabinet 26 may also contain pull-out drawers, tambours and/or storage spaces covered by doors, drapes, pull-down or roll-top covers or the like (not shown). It is contemplated that these pull-out drawers, tambours and storage spaces may be provided with conventional locking mechanisms to limit access to their contents. Furthermore, as discussed in more detail below, the shelves 28 may be made adjustable so as to be capable of being positioned at different positions within the storage cabinet 26 to suit the end user.

The pocket door 18 and associated storage means 20 are mounted for sliding movement into a wall pocket opening designated generally by the reference numeral 30. When the pocket door 18 and associated storage means 20 are slid out of the pocket opening 30, into the doorway opening 16, the doorway opening 16 is covered, and the associated storage means 20 is accessible only from the second room 24. Similarly, when the pocket door 18 and associated storage means 20 are slid into the pocket opening 30, the doorway opening 16 is uncovered. As can be appreciated, the pocket door 18 may be fitted with one or more conventional door handles (not shown) to facilitate opening and closing of the pocket door 18, as well as one or more conventional locking mechanisms (not shown) to prevent the pocket door 18 from opening.

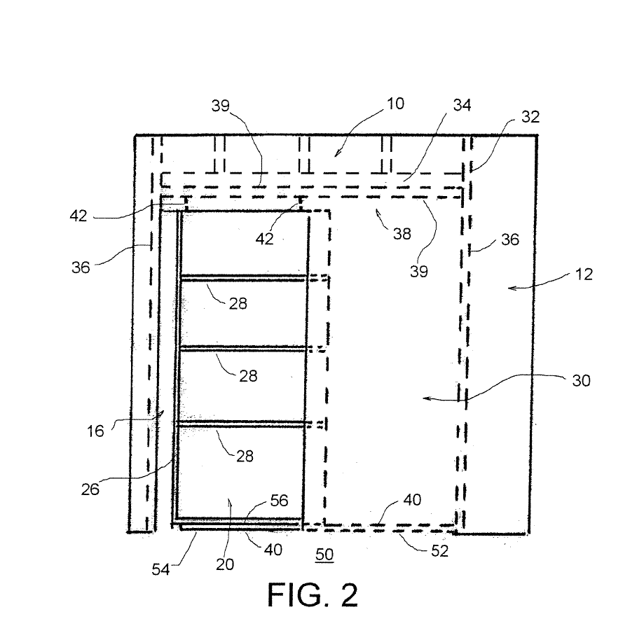

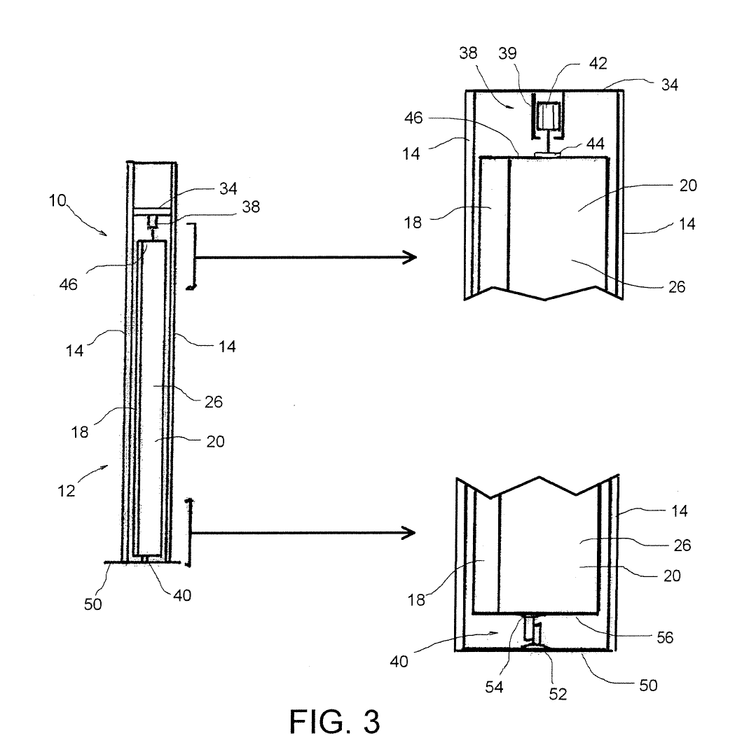

Turning now to FIGS. 2 and 3, the pocket door system 10 is shown installed within a rough frame opening 32 (shown in FIG. 2 in phantom outline) provided in a finished non-bearing partition wall assembly 12. The rough frame opening 32 includes an upper header 34 supported at its ends by a pair of studs 36. As can be appreciated, the pocket door system 10 is sized to fit widthwise into the partition wall assembly 12. Furthermore, the pocket door system 10 is sized lengthwise so that a suitable uncovered doorway opening 16 will be provided when the pocket door 18 and associated storage means 20 are slid into the pocket opening 30.

The pocket door system 10 includes a sliding means for supporting the pocket door 18 and associated storage means 20 and allowing them to slide into and out of the pocket opening 30. The sliding means preferably comprises an upper hanger assembly 38 and a lower sliding track 40.

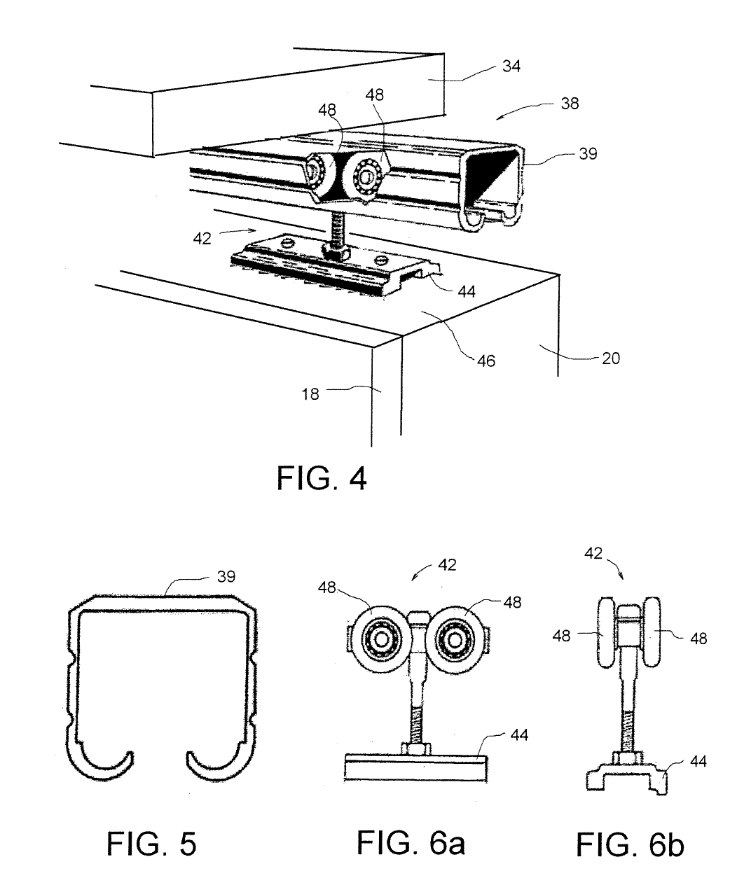

As best seen in FIGS. 3 and 4 the upper hanger assembly 38 is mounted directly to the upper header 34 of the wall assembly 12. The upper header 34 includes a track 39 and a pair of trolley assemblies 42 which are slidably supported by the track 39. The pocket door 18 and associated storage means 20 are slidably suspended above the floor 50 from the trolley assemblies 42.

By way of example, a suitable upper hangar assembly 38 is manufactured by K. N. Crowder Mfg. Inc. in association with the trademark CROWDERTRACK™. The track 39 has a generally C-shaped cross-section as shown in FIG. 5. The track 39 is sized and shaped to receive the pair of trolley assemblies 42. Each trolley assembly 42 comprises a bracket member 44 which is secured, as by wood screws, to an upper edge 46 of the pocket door 18 and/or the associated storage means 20. As best seen in FIGS. 6a and 6b each trolley assembly 42 includes two pairs of rollers 48, the rollers 48 of each pair being suitably spaced apart from one another so as to ride in the track 39. Thus, it can now be understood that the pocket door 18 and associated storage means 20 are suspended above the floor 50 for sliding movement between an open position, in which the doorway opening 16 is uncovered, and a closed position, in which the doorway opening 16 is covered.

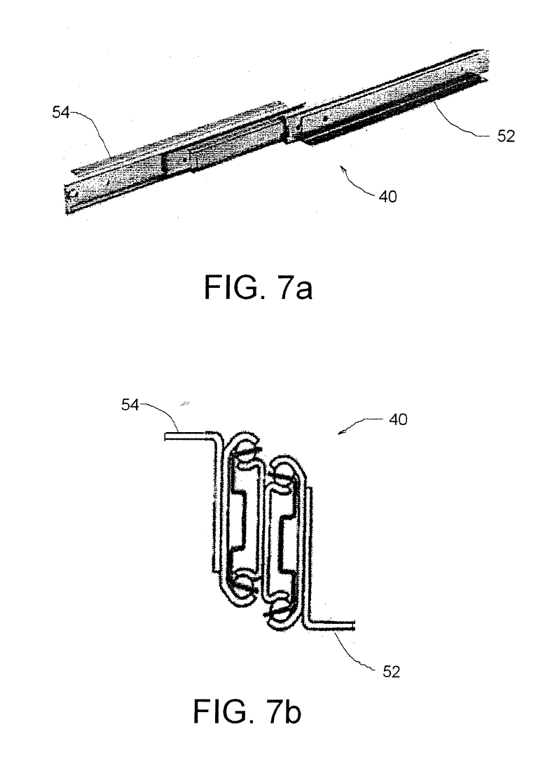

As best seen in FIGS. 2 and 3, the lower sliding track 40 slidably connects the pocket door 18 and associated storage means 20 to the floor 50, to stabilize the sliding motion by helping to prevent movement of the pocket door 18 and associated storage means 20 in a direction transverse to the sliding direction. The lower sliding track 40 is preferably is of the telescoping variety, having a first portion 52 mounted to the floor 50 and a second portion 54 mounted to the lower edge 56 of the pocket door 18 and/or the associated storage means 20. By way of example, a suitable lower sliding track 40 is manufactured by Accuride International Inc. under part number 301-2590 in association with the trade-mark ACCURIDE®. FIGS. 7a and 7b respectively show a perspective view and a side view of an exemplary lower sliding track 40.

Although it is preferable that the sliding means comprises both the upper hanger assembly 38 and the lower sliding track 40, it is contemplated that other embodiments may utilize either one or the other. What is important is that the pocket door 18 and associated storage means 20 are capable of slidable movement into and out of the pocket opening 30.

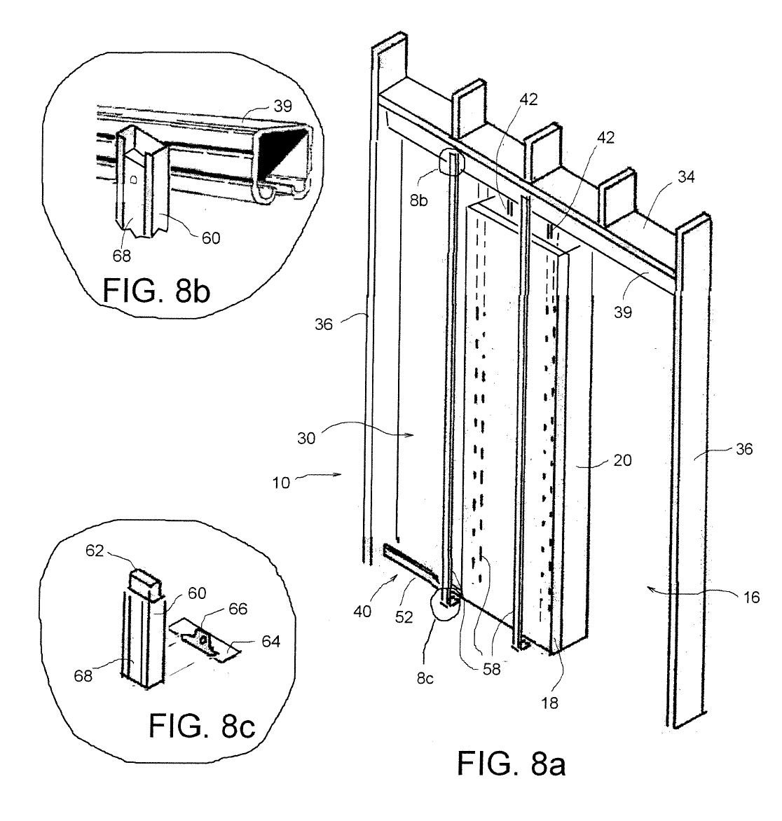

As shown in FIGS. 8a, 8b, and 8c, the pocket door system preferably includes pairs of composite stud assemblies designated generally by the reference number 58. The stud assemblies 58 help to provide a relatively rigid pocket opening 30 within which the pocket door 18 and associated storage means 20 can be stored. Each composite stud assembly 58 comprises an elongate metal channel member 60 having a generally C-shaped cross-section and dimensioned to receive, therewithin, a standard dimension 1×2 piece of lumber 62. The composite studs 58 are preferably positioned on opposite sides of the pocket door 18 and associated storage means 20 and are fixed either to the track 39 of the upper hanger assembly 38 as best seen in FIG. 8b, or the upper header 34, to provide rigidity to the pocket enclosure. At their lower ends, the composite stud assemblies 58 are secured to the floor 50 by a floor plate 64, which is best seen in FIG. 8c. Each floor plate 64 is preferably provided with an upstanding member 66 so configured as to be securable to the composite stud assembly 58. The foregoing means for fastening of the composite stud assembly 58 provides for a pocket opening 30 having uniform interior dimensions as well as uniform exterior dimensions slightly thicker than the thickness of a standard 2×4 framed wall. Outward opening of the channel members 60 permits a surface 68 of the 1×2 lumber piece 62 to be exposed exteriorly of the pocket opening 30 thus providing a nailing surface for a suitable wall covering 14.

Although, less preferred, it is also contemplated that conventional pieces of lumber or other material may be used in place of the composite stud assemblies 58 discussed above, or that they may be entirely omitted. What is important is that supporting members, such as the studs 58, should be positioned on opposite sides of the pocket door 18 and associated storage means 20 to provide rigidity to the pocket enclosure as well as a surface to which the wall surface structure 14 may be secured.

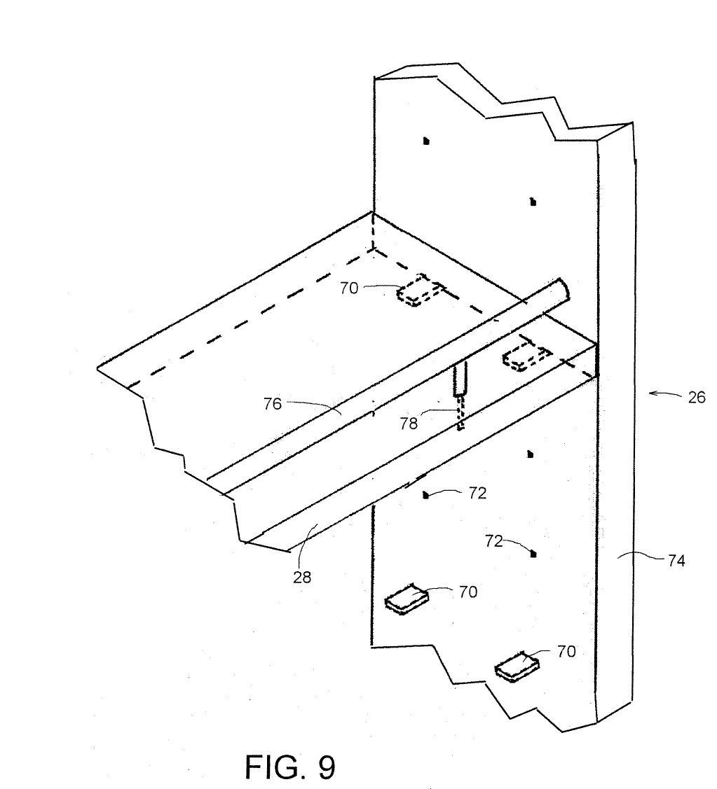

Referring to FIG. 9, there is shown an adjustable shelf 28 according to an embodiment of the pocket door system 10. As can be seen, the shelf 28 is supported by a pair of pegs 70 at each end (only one end shown). The pegs 70 are removably connected to pre-drilled holes 72 in a side wall 74 of the cabinet 26. As will be understood, the holes 72 are equally spaced at predetermined intervals so that the shelf 28 may be supported at various positions within the cabinet 26. A rail 76 may be attached to the shelf 28 to prevent articles (not shown) from falling off the shelf 28. Preferably, the rail 76 is attached to the shelf 28 via a threaded fastener 78 from the underside of the shelf 28. In this way the shelf 28 and rail 76 may be moved together within the cabinet 26 as is required by the user.

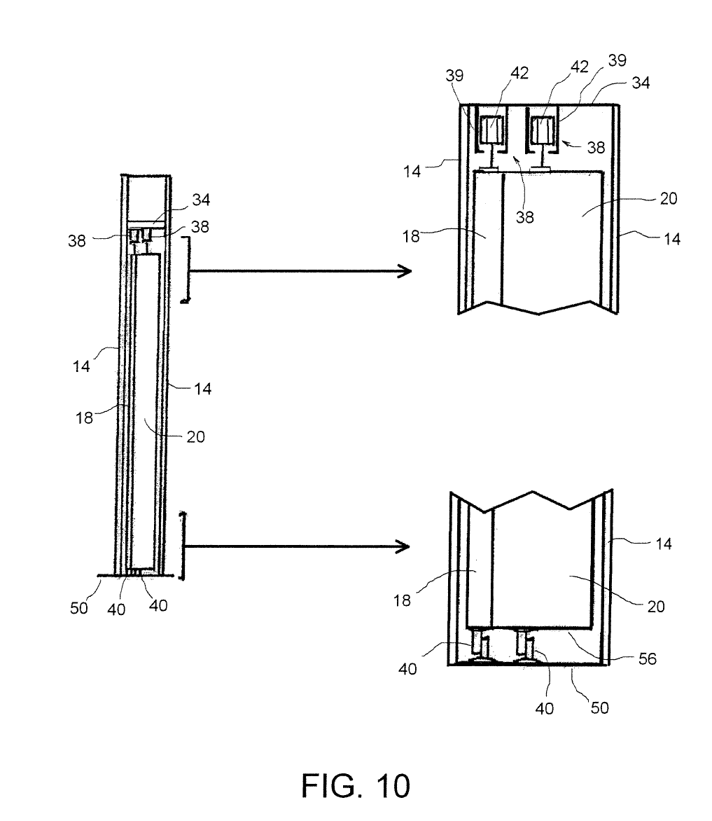

In FIG. 10, an alternative embodiment of a pocket door system 10 is illustrated as having two sets of upper hanger assemblies 38 and lower sliding tracks 40, one set supporting the pocket door 18 and the other set supporting the associated storage means 20. In this embodiment, the pocket door 18 and associated storage means 20 may be opened and closed independently of one another. This may be advantageous if for example the user wishes to predominantly maintain the storage means in the pocket opening 30, while still being able to open and close the pocket door 18. In another embodiment the associated storage means 20 may be constructed so as to be accessible from both rooms 22, 24 which it separates when it is moved into the doorway opening 16.

The advantages of a pocket door system as illustrated in FIGS. 1 to 10 can be appreciated in the context of its manufacturability and its installation simplicity. With relatively few components, there is provided in accordance with the present invention a pocket door system 10 having ease of installation and providing space saving advantages over conventional pocket door systems.

While reference has been made to various preferred embodiments of the invention other variations are comprehended by the broad scope of the appended claims. Some of these have been discussed in detail in this specification and others will be apparent to those skilled in the art. All such variations and alterations are comprehended by this specification are intended to be covered, without limitation.

1. A pocket door system comprising:
a pocket door sized and shaped to fit into a pocket opening in a wall;
a storage means associated with said pocket door, said storage means being sized and shaped to fit into said pocket opening with said pocket door; and
a means for sliding said pocket door and said associated storage means into and out of said pocket opening independently of one another.

2. A pocket door system as claimed in claim 11 wherein said storage means comprises a plurality of open faced shelves.

3. (canceled)

4. A pocket door system as claimed in claim 2 wherein said shelves are adjustable and may be positioned at different positions to suit the end user.

5-7. (canceled)

8. A pocket door system as claimed in claim 11 wherein said pocket door, when out of said pocket opening, covers a doorway opening.

9. A kit for installing a pocket door system in a doorway comprising:
a pocket door sized and shaped to fit into a pocket opening in a wall adjacent to the doorway;
a storage structure associated with said pocket door, said storage structure being sized and shaped to fit into said pocket opening with said pocket door; and
a slide assembly configured to reversibly slide each said pocket door and said associated storage structure into and out of said pocket opening independently of each other, said slide assembly comprising at least:
a first sliding track having one end attached to a bottom of said pocket door and having the other end secured to a floor in said pocket opening, said first sliding track telescoping outwardly from said pocket opening as said pocket door is slid out of said pocket opening to retain said bottom of said pocket door secured in said doorway, and said first sliding track retracting into said pocket opening when said pocket door is in said pocket opening,
a first upper sliding support mechanism to support an upper portion of said pocket door, and
a second sliding track having one end attached to a bottom of said storage structure and having the other end secured to a floor in said pocket opening, said second sliding track telescoping outwardly from said pocket opening as said storage structure is slid out of said pocket opening to retain said bottom of said storage structure secured in said doorway, and said second sliding track retracting into said pocket opening when said storage structure is in said pocket opening.

10. A pocket door system as claimed in claim 1 configured to selectively open and close communication between two rooms by reversibly sliding out of said pocket opening, wherein when said pocket door is located at least partially into said pocket opening, and said associated storage means is located at least partially out of said pocketing opening, at least a portion of said associated storage means is accessible from both of said rooms.

11. A pocket door system as claimed in claim 1 wherein said sliding means comprises:
at least a first upper sliding support mechanism to support an upper portion of said pocket door;
a first sliding track having one end attached to a bottom of said pocket door and having the other end secured to a floor in said pocket opening, said first sliding track extending outwardly from said pocket opening as said pocket door is slid out of said pocket opening to retain said bottom of said pocket door secured in said doorway, and said first sliding track retracting into said pocket opening when said pocket door is in said pocket opening;
at least a second upper sliding support mechanism to support an upper portion of said storage means; and
a second sliding track having one end attached to a bottom of said storage means and having the other end secured to a floor in said pocket opening, said second sliding track extending outwardly from said pocket opening as said storage means is slid out of said pocket opening to retain said bottom of said storage means secured in said doorway, and said second sliding track retracting into said pocket opening when said storage means is in said pocket opening.

12. A pocket door system as claimed in claim 11 wherein the one ends of the first and second sliding tracks are cantilevered from the ends which are secured to the floor.

13. A pocket door system as claimed in claim 11 wherein the threshold is unobstructed when the pocket door and the storage means are both received within the pocket opening.

14. A pocket door system as claimed in claim 9 wherein the ends of the first and second sliding tracks are cantilevered from the ends which are secured to the floor.

15. A pocket door system as claimed in claim 9 wherein the doorway is unobstructed when the pocket door and the storage structure are both received within the pocket opening.

16. A pocket door system as claimed in claim 9 wherein said storage structure comprises a plurality of open shelves.

17. A pocket door system as claimed in claim 16 wherein said shelves are adjustable and may be positioned at different positions to suit the end user.

18. A pocket door system as claimed in claim 16 wherein when the pocket door is disposed in the pocket opening and the storage structure is located in the doorway, the shelves are configured to be accessible to rooms on both sides of the doorway.

19. A pocket door system as claimed in claim 9 further including:
a second upper sliding support mechanism which supports an upper end of the storage structure.
